(19) United States
(12) Patent Application Publication
(10) Pub. No.: US 2026/0342417 A1
(43) Pub. Date: Oct. 29, 2026

(54) METHOD AND APPARATUS FOR TRANSMITTING INDICATION INFORMATION, AND READABLE STORAGE MEDIUM

(71) Applicant: Beijing Xiaomi Mobile Software Co., Ltd., Beijing (CN)

(72) Inventor: Rui ZHOU, Beijing (CN)

(21) Appl. No.: 19/103,696

(22) PCT Filed: Aug. 18, 2022
(86) PCT No.: PCT/CN2022/113380

§ 371 Date: Feb. 13, 2025

(51) Int. Cl. H04B 7/06; H04W 72/232

(52) U.S. Cl. CPC H04B 7/06952; H04W 72/232

(57) ABSTRACT

A method for receiving indication information is performed by user equipment (UE). The method includes: receiving first indication information transmitted by a first number of network devices in accordance with a setting configuration scheme, wherein the first indication information indicates activated transmission configuration indication (TCI) states configured by respective network devices, and the first number of network devices include a first network device and at least one second network device in a same cell; performing beam switching of a first number of beams at a same moment, and performing mobility measurements simultaneously on the respective network devices using a first number of reception beams corresponding to the activated TCI states after the beam switching.

### CROSS-REFERENCE TO RELATED APPLICATION

This application is the U.S. national phase application of International Application No. PCT/CN2022/113380, filed on Aug. 18, 2022, the disclosure of which is incorporated herein by reference in its entirety.

### TECHNICAL FIELD

The present disclosure relates to the field of wireless communication technologies, and in particular, relates to a method and apparatus for transceiving indication information, and a readable storage medium.

### BACKGROUND

In fifth generation (5G) wireless communication systems, beamforming technologies are adopted in a millimeter wave frequency range 2 (FR2) frequency band. An omnidirectional antenna reception pattern is adopted in a low frequency range 1 (FR1) frequency band. In contrast, when user equipment (UE) receives signals in the FR2 frequency band, additional beamforming and management technologies for reception beams are introduced to help achieve a greater uplink coverage range and a better transmission rate by using the best reception beams to receive the signals. With the introduction of the beam concept, for physical resources at the same time and frequency, the UE can multiplex the resources through different beams. For example, the UE may receive the signals in a reception beam scanning manner, which achieves better coverage of reception angles using multiple beams.

In a multiple transmission and reception point (TRP) scenario, a cell containing multiple TRPs may provide better coverage. However, a scheduling problem needs to be solved in this scenario.

### SUMMARY

The present disclosure provides a method and apparatus for transceiving indication information, and a readable storage medium.

In a first aspect, the present disclosure provides a method for receiving indication information, performed by user equipment (UE), and the method includes: receiving first indication information transmitted by a first number of network devices in accordance with a setting configuration scheme, wherein the first indication information indicates activated transmission configuration indication (TCI) states configured by respective network devices, and the first number of network devices include a first network device and at least one second network device in a same cell; performing beam switching of a first number of beams at a same moment, and performing mobility measurements simultaneously on the respective network devices using a first number of reception beams corresponding to the activated TCI states after the beam switching.

In the method of the present disclosure, multiple network devices within the same cell may issue the activated TCI states in accordance with the setting configuration scheme, respectively. According to the TCI states issued by the network devices in accordance with the setting configuration scheme, the UE achieve simultaneous switching of multiple reception beams, so that the measurements on the multiple network devices can be performed simultaneously, which is conducive to reducing a measurement delay.

In a second aspect, the present disclosure provides a method for transmitting indication information, performed by a first network device, and the method includes: receiving capability information transmitted by UE, wherein the capability information indicates a first number of reception beams supported by the UE at a same moment; and transmitting second indication information to a second number of second network devices in a same cell, wherein the second indication information indicates a setting configuration scheme for TCI states supported by the UE, and the second number is equal to or less than the first number.

In the method of the present disclosure, the first network device learns the reception beams that the UE can support at the same moment based on the capability information reported by the UE. On this basis, the first network device may transmit the indication information to a corresponding number of second network devices to indicate these second network devices to issue the TCI states to the UE in accordance with the setting configuration scheme, so that the UE can achieve simultaneous switching of multiple reception beams within its own capability.

In a third aspect, the present disclosure provides a method for transmitting indication information, performed by a second network device, and the method includes: receiving second indication information transmitted by a first network device, wherein the second indication information indicates a setting configuration scheme for TCI states supported by UE, and the second network device and the first network device are located in a same cell; and transmitting first indication information to the UE in accordance with the setting configuration scheme, wherein the first indication information indicates an activated TCI state correspondingly configured by the second network device.

In the method of the present disclosure, the second network device issues the TCI state to the UE in accordance with a setting configuration scheme according to the indication information from the first network device, so that the UE can achieve simultaneous switching of multiple reception beams within its own capability, which is conducive for the UE to perform measurements simultaneously to reduce the delay.

It is to be understood that the foregoing general description and the following detailed description are illustrative and explanatory only and are not restrictive of the present disclosure.

### BRIEF DESCRIPTION OF THE DRAWINGS

The drawings described herein are used to provide further understanding of examples of the present disclosure and constitute a part of the present disclosure. The illustrations of the examples of the present disclosure and their descriptions are used to explain the examples of the present disclosure and do not constitute improper limitations on the examples of the present disclosure.

The accompanying drawings, which are incorporated in and constitute a part of this specification, illustrate the illustrations consistent with the examples of the present disclosure and, together with the specification, serve to explain the principles of the examples of the present disclosure.

FIG. 1 is a schematic structural diagram of a wireless communication system provided in an example of the present disclosure.

FIG. 2 illustrates a flowchart of a method for transceiving indication information according to an example.

FIG. 3 illustrates a flowchart of another method for transceiving indication information according to an example.

FIG. 4 illustrates a schematic diagram of reception beams of user equipment according to an example.

FIG. 5 illustrates a flowchart of a method for receiving indication information according to an example.

FIG. 6 illustrates a flowchart of another method for receiving indication information according to an example.

FIG. 7 illustrates a schematic diagram of a time axis according to an example.

FIG. 8 illustrates a flowchart of another method for receiving indication information according to an example.

FIG. 9 illustrates a schematic diagram of a time axis according to an example.

FIG. 10 illustrates a flowchart of a method for transmitting indication information according to an example.

FIG. 11 illustrates a flowchart of a method for receiving indication information according to another example.

FIG. 12 illustrates a block diagram of an apparatus for receiving indication information according to an example.

FIG. 13 illustrates a block diagram of user equipment according to an example.

FIG. 14 illustrates a block diagram of an apparatus for transmitting indication information according to an example.

FIG. 15 illustrates a block diagram of a communication device according to an example.

FIG. 16 illustrates a block diagram of an apparatus for receiving indication information according to an example.

### DETAILED DESCRIPTION OF THE EMBODIMENTS

Examples of the present disclosure are further described in conjunction with the accompanying drawings and the detailed implementations.

Examples will be described in detail herein, whose illustrations are illustrated in the accompanying drawings. Where the following descriptions involve the drawings, like numerals in different drawings refer to like or similar elements unless otherwise indicated. The implementations described in the following examples do not represent all implementations consistent with the examples of the present disclosure. Rather, they are merely examples of apparatuses and methods consistent with some aspects of the present disclosure as detailed in the appended claims.

The terms used in the examples of the present disclosure are for the purpose of describing particular examples only, and are not intended to limit the examples of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred to as second information; and similarly, second information may also be referred to as first information. Depending on the context, the word “if” as used herein may be interpreted as “when,” “upon,” or “in response to determining.”

The following describes the examples of the present disclosure in detail. Illustrations of the examples are illustrated in the accompanying drawings, with the same or similar reference numerals referring to the same or similar elements throughout. The examples, which are described below with reference to the accompanying drawings, are illustrated and are intended to explain the present disclosure, but should not be construed as a limitation of the present disclosure.

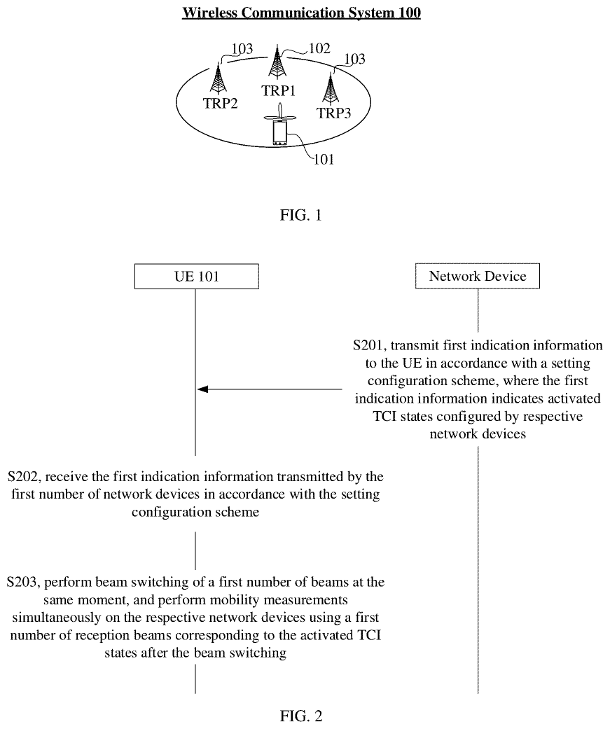

As illustrated in FIG. 1, a method for transceiving indication information provided by examples of the present disclosure may be applied to a wireless communication system 100, which may include a first network device 102, second network devices 103, and user equipment (UE) 101.

The UE 101 is configured to support carrier aggregation and may be connected to multiple carrier unit of the first network device 102 or the second network devices 103, including a primary carrier unit and one or more secondary carrier units.

It is to be understood that the wireless communication system 100 is applicable to both low-frequency scenarios and high-frequency scenarios. Application scenarios of the wireless communication system 100 include, but are not limited to, a long term evolution (LTE) system, a LTE frequency division duplex (FDD) system, a LTE time division duplex (TDD) system, a worldwide interoperability for micro wave access (WiMAX) communication system, a cloud radio access network (CRAN) system, a future fifth-generation (5G) system, a new radio (NR) communication system or a future evolved public land mobile network (PLMN) system, etc.

The illustrated UE 101 may be a terminal, an access terminal, a terminal unit, a terminal station, a mobile station (MS), a remote station, a remote terminal, a mobile terminal, a wireless communication device, a terminal agent or a terminal device, etc. The UE 101 may be equipped with a wireless transceiving function, and may perform communications (such as wireless communications) with one or more network devices of one or more communication systems, and accept network services provided by the network devices. The network devices here include, but are not limited to, the illustrated network devices.

The UE 101 may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in the future 5G network, or a terminal device in the future evolved PLMN network, etc.

The first network device 102 or the second network device 103 may be an access network device (or called an access network station). The access network device refers to a device that provides a network access function, for example, a radio access network (RAN) base station, etc. The first network device 102 or the second network device 103 may specifically include a base station (BS), or include the base station and a radio resource management device for controlling the base station, etc. The network device 102 may further include a relay station (a relay device), an access point, a base station in the future 5G network, a base station in the future evolved PLMN network, or an NR base station, etc. The first network device 102 or the second network device 103 may be a wearable device or a vehicle-mounted device. The first network device 102 or the second network device 103 may further be a communication chip having a communication module.

For example, the first network device 102 or the second network device 103 includes, but is not limited to, a next-generation base station (gnodeB or gNB) in 5G, an evolved node B (eNB) in an LTE system, a radio network controller (RNC), a node B (NB) in a wideband code division multiple access (WCDMA) system, a radio controller under a CRAN system, a base station controller (BSC), a base transceiver station (BTS) in a global system for mobile communications (GSM) system or a code division multiple access (CDMA) system, a home base station (for example, a home evolved nodeB or a home node B (HNB)), a baseband unit (BBU), a transmitting and receiving point (TRP), a transmitting point (TP) or a mobile switching center, etc.

As illustrated in FIG. 1, the first network device 102 and the second network devices 103 are TRPs located in the same cell. The cell including multiple TRP nodes can achieve better coverage. The first network device 102 may be a primary base station in the cell. The first network device 102 and the second network devices 103 share information of this cell. The UE 101 may access the cell through any TRP. In the multi-TRP scenario, each TRP may issue signaling to the UE 101, which is configured to activate its corresponding reception beam, so that the UE 101 can switch to the reception beam corresponding to the TRP to measure the TRP.

When the UE 101 is expected to switch to the beams corresponding to the multiple TRPs at the same time to complete the measurements on the multiple TRPs at the same time, the UE 101 may not receive the configuration and activation signalings corresponding to the multiple TRPs at the same time because the manners in which the multiple TRPs configure to activate their corresponding reception beams may be different. Therefore, the UE 101 may not achieve beam switching of the multiple TRPs at the same time.

In the examples of the present disclosure, a method for transceiving indication information is provided. Referring to FIG. 2, FIG. 2 is a method for transceiving indication information according to an example. As illustrated in FIG. 2, the method includes steps S201-S203.

At step S201, a first number of network devices transmit first indication information to the UE 101 in accordance with a setting configuration scheme. The first number of network devices include the first network device 102 and at least one second network device 103.

At step S202, the UE 101 receives the first indication information transmitted by the first number of network devices in accordance with the setting configuration scheme, where the first indication information indicates activated transmission configuration indication (TCI) states configured by respective network devices, and the first number of network devices include a first network device 102 and at least one second network device 103 in the same cell.

At step S203, the UE 101 performs beam switching of a first number of beams at the same moment, and performs mobility measurements simultaneously on the respective network devices using a first number of reception beams corresponding to the activated TCI states after the beam switching.

In some implementations, the first number is greater than or equal to 2. The first number of network devices, i.e., the first number of TRPs, include one first network device 102 and at least one second network device 103. All the first number of TRPs are located in the same cell. The first network device 102 may be a primary base station among the first number of TRPs.

In an example, the first network device 102 is TRP1, and the second network devices 103 are TRP2 and TRP3, respectively.

In some implementations, the UE 101 may use different reception beams to receive signals from the respective TRPs. In some scenarios, such as where the reception beam used by the UE 101 to receive each TRP changes as the position of the UE 101 changes, the beam switching is required. For example, for TRP1, the UE 101 first uses one reception beam to receive a reference signal (RS) of TRP1. When the position of the UE 101 changes, the UE 101 is to perform the beam switching and uses a new reception beam after the beam switching to receive the reference signal of TRP1.

In this beam switching scenario, the UE 101 is to determine the new reception beam corresponding to the activated TCI state configured by each TRP, and then perform the beam switching to update the used reception beams.

In some implementations, before the case of the beam switching, any one of the multiple TRPs may transmit a TCI state table (list) corresponding to the TRP for indication. The TCI state list may include multiple TCI states corresponding to the TRP, with each TCI state corresponding to one reception beam.

Then, in the scenario involving the beam switching, the TRP transmits the first indication information to the UE 101 to indicate the activated TCI state that is configured this time. After receiving the first indication information, the UE 101 determines the reception beam corresponding to the activated TCI state and performs the beam switching to switch to the reception beam.

In some implementations, if receiving the first indication information respectively transmitted by the multiple TRPs, it is only after the processing (e.g., a demodulation) within respective processing delays that the UE 101 can learn the reception beams corresponding to the activated TCI states and perform the switching. The processing delays of the UE 101 are different when the signalings carrying the first indication information are different.

In some implementations, after the multiple TRPs issue respective first indication information in accordance with the setting configuration scheme, the UE 101 completes the processing at the same moment and learn the reception beam corresponding to the activated TCI state of each TRP. Therefore, the UE 101 performs the switching at the same moment.

In some implementations, the setting configuration scheme indicates: transmitting through the same type of control signalings at the same transmission moment. Alternatively, the setting configuration scheme indicates: transmitting at transmission moments corresponding to control signalings.

In some implementations, the control signaling is a radio resource control (RRC) signaling, a media access control control element (MAC-CE) signaling, or downlink control information (DCI).

In some implementations, after simultaneously performing the switching of multiple reception beams, the UE 101 performs the mobility measurements simultaneously on the respective TRPs using the multiple switched reception beams. For example, for any TRP, the UE 101 receives the RS of the TRP through the switched reception beam, measures a reference signal received power (RSRP) of the RS, and may report the corresponding measurement result.

In the example of the present disclosure, multiple network devices in the same cell may issue respective activated TCI states in accordance with the setting configuration scheme, and the UE 101 achieves simultaneous switching of multiple reception beams according to the TCI states issued by the network devices in accordance with the setting configuration scheme, so that the measurements on the multiple network devices can be performed simultaneously, which is conducive to reducing a measurement delay.

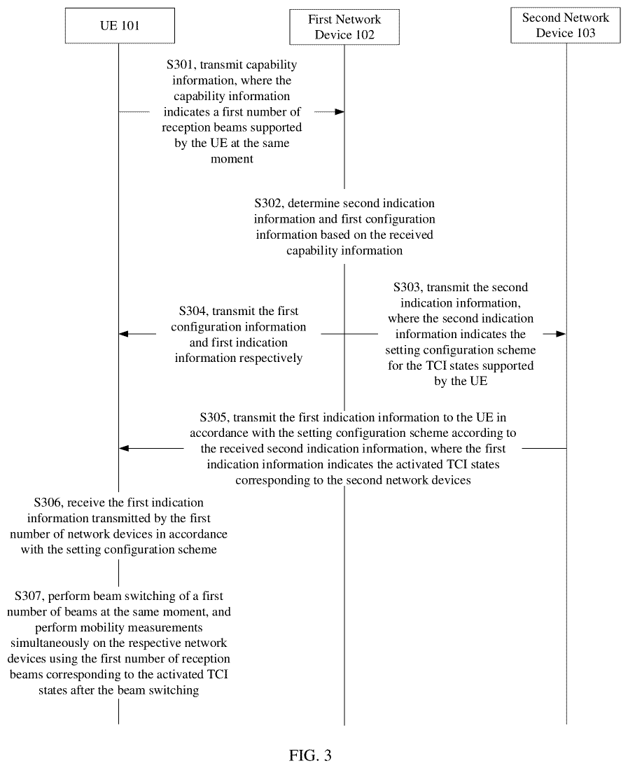

In the examples of the present disclosure, a method for transceiving indication information is provided. Referring to FIG. 3, FIG. 3 is a method for transmitting indication information according to an example. As illustrated in FIG. 3, the method includes steps S301-S307.

At step S301, the UE 101 transmits capability information to the first network device 102, where the capability information indicates a first number of reception beams supported by the UE 101 at the same moment.

At step S302, the first network device 102 determines second indication information and first configuration information based on the received capability information.

At step S303, the first network device 102 transmits the second indication information to a second number of second network devices 103 in the same cell, where the second indication information indicates the setting configuration scheme for the TCI states supported by the UE 101, and the second number is equal to or less than the first number.

At step S304, the first network device 102 transmits the first configuration information and first indication information respectively to the UE 101, where the first configuration information indicates the UE 101 to perform mobility measurements simultaneously using the first number of reception beams, and the first indication information indicates an activated TCI state configured by the first network device 102.

At step S305, the second number of second network devices 103 transmit the first indication information to the UE 101 in accordance with the setting configuration scheme according to the received second indication information, where the first indication information indicates the activated TCI states configured by the respective second network devices 103.

At step S306, the UE 101 receives the first indication information transmitted by the first number of network devices in accordance with the setting configuration scheme. The first indication information indicates the activated TCI states configured by the respective network devices. The first number of network devices include one first network device 102 and the second number of second network devices 103 in the same cell.

At step S307, the UE 101 performs beam switching of a first number of beams at the same moment, and performs mobility measurements simultaneously on the respective network devices using the first number of reception beams corresponding to the activated TCI states after the beam switching.

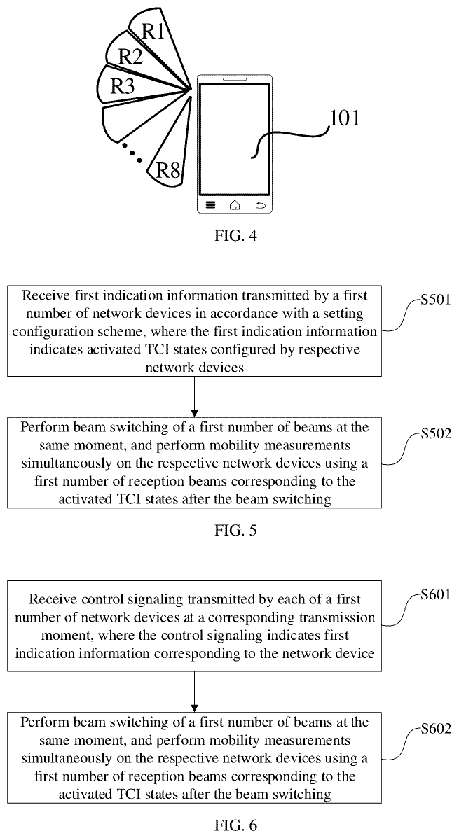

In some implementations, FIG. 4 is a schematic diagram of reception beams of the UE 101 according to an example. The capability that the UE 101 supports reception beams is described in combination with FIG. 4. The UE 101 may achieve better receiving angle coverage in a manner of scanning 8 reception beams in the FR2 frequency band. For example, the 8 reception beams are represented by R1, R2, . . . , R7 and R8, respectively. Each reception beam covers a range of 15°. By adjusting different reception beams for reception, the 8 reception beams may cover a range of 120°.

In some implementations, depending on the capabilities of different UE 101, the counts of reception beams supported by them at the same moment may be different. For example, the first number is 2, indicating that the UE is able to support two reception beams at the same moment. For example, the two reception beams are R1 and R8, respectively.

In some implementations, the first network device 102 adaptively configures the first configuration information based on the capability information of the UE 101. Furthermore, the first network device 102 transmits the second indication information to the second number of second network devices 103 to inform these second network devices 103 of the setting configuration scheme supported by the UE 101.

In an example, in a scenario where the first network device 102 transmits the first indication information corresponding to itself to the UE 101, the second number=(the first number—1).

In other examples, the first network device 102 may not transmit the first indication information corresponding to itself to the UE 101. That is, in a scenario where the first network device 102 does not transmit the first indication information corresponding to itself to the UE 101, the second number=the first number, which means that, in this example, the first indication information is transmitted by the first number of second network devices 103 in the cell.

In some implementations, in a scenario with the first number of TRPs, all of the first network device 102 and the at least one second network device 103 are located in the same cell. The first network device 102 may be a primary base station among the first number of TRPs.

In some implementations, if receiving the first indication information respectively transmitted by multiple TRPs, it is only after the processing within respective processing delays that the UE 101 can learn the reception beams corresponding to the activated TCI states and perform the switching. The processing delays of the UE 101 are different when the signalings carrying the first indication information are different.

In some implementations, after multiple TRPs issue respective first indication information in accordance with the setting configuration scheme, the UE 101 completes the processing at the same moment and learn the reception beam corresponding to the activated TCI state of each TRP. Therefore, the UE 101 performs the switching at the same moment.

In some implementations, the setting configuration scheme indicates: transmitting through the same type of control signalings at the same transmission moment. Alternatively, the setting configuration scheme indicates: transmitting at transmission moments corresponding to control signalings.

In some implementations, the control signaling is an RRC signaling, an MAC-CE signaling or DCI.

In some implementations, after performing the switching of multiple reception beams simultaneously, the UE 101 performs the mobility measurements on the respective TRPs simultaneously using multiple switched reception beams. For example, for any TRP, the UE 101 receives a RS of the TRP through the switched reception beam, measures a RSRP of the RS, and may report the corresponding measurement result.

In the example of the present disclosure, the first network device 102 learns the reception beams able to be supported by the UE 101 at the same moment based on the capability information reported by the UE 101. On this basis, the first network device 102 may adaptively perform a measurement configuration for the UE 101, and transmit the second indication information to a corresponding number of second network devices for indicating these second network devices to issue the TCI states to the UE 101 in accordance with the setting configuration scheme. Therefore, the UE 101 can achieve simultaneous switching of multiple reception beams within its own capabilities and according to the configuration from the first network device 102. In addition, by implementing the measurements on the different TRPs using multiple reception beams, it can effectively reduce a measurement delay.

In the examples of the present disclosure, a method for receiving indication information is provided, which is performed by UE 101. Referring to FIG. 5, FIG. 5 is a method for receiving indication information according to an example. As illustrated in FIG. 5, the method includes steps S501-S502.

At step S501, the UE 101 receives first indication information transmitted by a first number of network devices in accordance with a setting configuration scheme, where the first indication information indicates activated TCI states configured by respective network devices. The first number of network devices include one first network device 102 and at least one second network device 103 in the same cell.

At step S502, the UE 101 performs beam switching of a first number of beams at the same moment, and performs mobility measurements simultaneously on the respective network devices using a first number of reception beams corresponding to the activated TCI states after the beam switching.

In some implementations, in a scenario with the first number of TRPs, all of the first network device 102 and the at least one second network device 103 are located in the same cell. The first network device 102 may be a primary base station among the first number of TRPs.

In an example, the first network device 102 is TRP1, and the second network devices 103 are TRP2 and TRP3, respectively.

In some implementations, the UE 101 may receive the first indication information transmitted by the first network device among the first number of network devices in accordance with the setting configuration scheme, and/or receive the first indication information transmitted by the second network devices among the first number of network devices in accordance with the setting configuration scheme.

In an example, the first number of network devices include one first network device 102 and a second number of second network devices 103. Each of the first number of network devices may transmit the first indication information corresponding to itself to the UE 101 to indicate the activated TCI state correspondingly configured by itself.

In an example, the first network device 102 acts as the primary base station for receiving the capability information of the UE 101 and transmitting second indication information to the second network devices 103. In this example, the second number is equal to the first number, and the corresponding first indication information may be transmitted to the UE by various second network devices 103, respectively.

In some implementations, any of the first number of TRPs may transmit to the UE 101 a TCI state list corresponding to the TRP for indication. In a scenario involving the beam switching, by transmitting the first indication information to the UE 101, the TRP indicates the activated TCI state that is configured this time. The UE 101 switches to the reception beam corresponding to the activated TCI state to receive a RS of the TRP.

In an example, TRP1 transmits DCI to the UE 101 to configure the TCI state list corresponding to TRP1. In a scenario involving the beam switching, TRP1 transmits the first indication information to configure the TCI state activated this time in the TCI state list. The UE 101 switches to the reception beam corresponding to the activated TCI state to receive the signal of TRP1.

In some implementations, after the first number of TRPs issue respective first indication information in accordance with the setting configuration scheme, the UE 101 completes the processing at the same moment and learns the reception beam corresponding to the activated TCI state of each TRP. Therefore, the UE 101 performs the switching at the same moment.

In some implementations, the setting configuration scheme indicates: transmitting through the same type of control signalings at the same transmission moment. Alternatively, the setting configuration scheme indicates: transmitting at transmission moments corresponding to control signalings.

In some implementations, the control signaling is an RRC signaling, an MAC-CE signaling or DCI.

In some implementations, after performing the switching of multiple reception beams simultaneously, the UE 101 performs the mobility measurements on the respective TRPs simultaneously using the multiple switched reception beams. For example, for any TRP, the UE 101 receives the RS of the TRP through the switched reception beam and measures a RSRP of the RS.

In the example of the present disclosure, multiple network devices in the same cell may issue respective activated TCI states in accordance with the setting configuration scheme, and the UE 101 achieves simultaneous switching of multiple reception beams according to the TCI states issued by the network devices in accordance with the setting configuration scheme, so that the measurements on the multiple network devices can be performed simultaneously, which is conducive to reducing a measurement delay.

In the examples of the present disclosure, a method for receiving indication information is provided, which is performed by UE 101. Referring to FIG. 6, FIG. 6 illustrates a method for receiving indication information according to an example.

In a scenario where a setting configuration scheme indicates transmitting at transmission moments corresponding to control signalings, as illustrated in FIG. 6, the method includes steps S601-S602.

At step S601, the UE 101 receive control signaling transmitted by each of a first number of network devices at a corresponding transmission moment, where the control signaling indicates first indication information corresponding to the network device. The first indication information indicates an activated TCI state corresponding to the network device. The first number of network devices include one first network device 102 and at least one second network device 103 in the same cell.

At step S602, the UE 101 performs beam switching of a first number of beams at the same moment, and performs mobility measurements simultaneously on the respective network devices using a first number of reception beams corresponding to the activated TCI states after the beam switching.

In some implementations, if receiving the first indication information respectively transmitted by the first number of TRPs, it is only after the processing within respective processing delays that the UE 101 can learn the reception beams corresponding to the activated TCI states and perform the switching. The processing delays of the UE 101 are different when the signalings carrying the first indication information are different.

In some implementations, the first network device 102 informs various second network devices 103 of the transmission moments corresponding to different signalings in combination with the processing delays of different signalings. For example, the transmission moments corresponding to different types of signalings are indicated in the second indication information.

In some implementations, according to the adopted signaling, the first network device 102 or the second network device 103 transmits the signaling carrying the first indication information at the transmission moment corresponding to the type of signaling.

In some implementations, the control signaling is an RRC signaling, an MAC-CE signaling or DCI.

In some implementations, the processing delay of the RRC signaling>the processing delay of the MAC-CE signaling>the processing delay of the DCI. Therefore, the transmission moment of the TRP adopting the RRC signaling is earlier than that of the TRP transmitting other signalings.

In some implementations, different types of signalings are transmitted sequentially in different orders along a time axis, and the time at which the signalings are received by the UE 101 is also different.

In the example of the present disclosure, the network devices transmit the first indication information in different orders along the time axis, so that the UE 101 may perform processing at different processing starting moments, thereby completing the processing at the same moment, learning the reception beam corresponding to the activated TCI state of each TRP, and thus performing the switching of multiple reception beams at the same moment.

In the examples of the present disclosure, a method for receiving indication information is provided, which is performed by UE 101.

In a scenario where the setting configuration scheme indicates transmitting at transmission moments corresponding to control signalings, the method includes steps S601, S601′, and S602.

At step S601, the UE 101 receive the control signaling transmitted by each of a first number of network devices at the corresponding transmission moment, where the control signaling indicates first indication information corresponding to the network device. The first indication information indicates an activated TCI state corresponding to the network device. The first number of network devices include one first network device 102 and at least one second network device 103 in the same cell.

At step S601′, the reception beams corresponding to the TCI states indicated by the first indication information in a first number of control signalings are determined at the same moment by taking a moment when each control signaling is received as a processing starting moment of the control signaling and processing the control signalings within a processing delay corresponding to the control signaling according to the processing starting moments corresponding to different control signalings.

At step S602, the UE 101 performs beam switching of a first number of beams at the same moment, and performs mobility measurements simultaneously on the respective network devices using a first number of reception beams corresponding to the activated TCI states after the beam switching.

In some implementations, the control signaling is an RRC signaling, an MAC-CE signaling or DCI.

In some implementations, if the control signalings from the multiple TRPs are the same, their corresponding transmission moments are also the same.

In some implementations, the processing delay of the RRC signaling>the processing delay of the MAC-CE signaling>the processing delay of the DCI. Therefore, the transmission moment of the TRP adopting the RRC signaling is earlier than that of the TRP transmitting other signalings.

In some implementations, different types of signalings are transmitted sequentially in different orders along a time axis, and the time at which the signalings are received by the UE 101 is also different. For the signaling with the longer processing delay, the UE 101 is to receive it earlier and process it earlier with taking the reception moment as the processing starting moment.

In an example, the first network device 102 is TRP1, and there are two second network devices 103, namely TRP2 and TRP3.

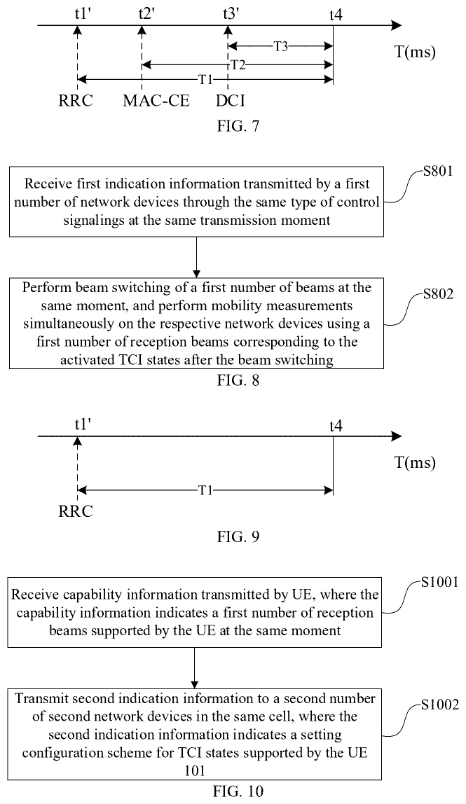

Combined with FIG. 7, the TRP1 transmits an RRC signaling at moment t1, and the RRC signaling indicates an activated TCI state1 corresponding to the TRP1. The TRP2 transmits an MAC-CE signaling at moment t2, and the MAC-CE signaling indicates an activated TCI state2 corresponding to the TRP2. The TRP3 transmits DCI at moment t3, and the DCI indicates an activated TCI state3 corresponding to the TRP3.

The UE 101 receives the RRC signaling at moment t1′, and demodulates the RRC signaling within a processing delay T1 corresponding to the RRC signaling with the moment t1′ taken as the processing starting moment. The moment when the processing is completed is t4.

The UE 101 receives the MAC-CE signaling at moment t2′, and demodulates the MAC-CE signaling within a processing delay T2 corresponding to the MAC-CE signaling with the moment t2′ taken as the processing starting moment. The moment when the processing is completed is t4.

The UE 101 receives the DCI at moment t3′, and demodulates the DCI within a processing delay T3 corresponding to the DCI with the moment t3′ taken as the processing starting moment. The moment when the processing is completed is t4.

At the moment t4, the UE 101 performs the beam switching simultaneously, so as to form a reception beam R1 corresponding to the TCI state1, a reception beam R2 corresponding to the TCI state2, and a reception beam R3 corresponding to the TCI state3 simultaneously, and performs measurements simultaneously on the corresponding TRPs using these three reception beams. For example, the measurement on the TRP1 is performed through R1, the measurement on the TRP2 is performed through R2, and the measurement on the TRP3 is performed through R3.

In this example, in combination with the transmission moments of different TRPs, the UE 101 performs the processing according to different activation moments on the time axis, thereby performing the beam switching at the same moment.

In the examples of the present disclosure, a method for receiving indication information is provided, which is performed by UE 101. Referring to FIG. 8, FIG. 8 illustrates a method for receiving indication information according to an example.

In a scenario where the setting configuration scheme indicates transmitting through the same type of control signalings at the same transmission moment. As illustrated in FIG. 8, the method includes steps S801-S802.

At step S801, the UE 101 receives first indication information transmitted by a first number of network devices through the same type of control signalings at the same transmission moment. The first indication information indicates activated TCI states of the respective network devices. The first number of network devices include a first network device 102 and at least one second network device 103 in the same cell.

At step S802, the UE 101 performs beam switching of a first number of beams at the same moment, and performs mobility measurements simultaneously on the respective network devices using a first number of reception beams corresponding to the activated TCI states after the beam switching.

In some implementations, the control signaling is an RRC signaling, an MAC-CE signaling or DCI.

In an example, all the first number of TRPs adopt the RRC signaling to transmit the first indication information, respectively.

In an example, all the first number of TRPs adopt the MAC-CE signaling to transmit the first indication information, respectively.

In an example, all the first number of TRPs adopt the DCI to transmit the first indication information, respectively.

In some implementations, the signalings adopted by the first number of TRPs are of the same type, and the processing delays of the UE 101 are also the same. Therefore, the transmission moments of the first number of TRPs are the same, and the UE 101 processes each TRP signaling at the same processing starting moment, which is conducive to the simultaneous switching.

In an example, the first network device 102 is TRP1, and there are two second network devices 103, namely TRP2 and TRP3.

Combined with FIG. 9, the TRP1 transmits the RRC signaling indicating an activated TCI state1 at moment t1, the TRP2 transmits the RRC signaling indicating an activated TCI state2 at moment t1, and the TRP3 transmits the RRC signaling indicating an activated TCI state3 at moment t1.

The UE 101 receives the RRC signalings corresponding to these three TRPs at moment t1′, takes the moment t1′ as the processing starting moment, and processes these three RRC signalings simultaneously within a processing delay T1 corresponding to the RRC signalings. The moment when the processing is completed is t4.

At the moment t4, the UE 101 performs the beam switching simultaneously, so as to form a reception beam R1 corresponding to the TCI state1, a reception beam R2 corresponding to the TCI state2, and a reception beam R3 corresponding to the TCI state3 simultaneously, and performs the measurements on the respective TRPs using these three reception beams simultaneously. For example, the measurement on the TRP1 is performed through R1, the measurement on the TRP2 is performed through R2, and the measurement on the TRP3 is performed through R3.

In this example, different TRPs transmit the same type of control signalings at the same transmission moment. After receiving the signalings from different TRPs at the same time, the UE 101 processes them simultaneously, thereby performing the beam switching at the same moment.

In the examples of the present disclosure, a method for receiving indication information is provided, which is performed by UE 101. The method includes steps S701-S704.

At step S701, the UE 101 transmits capability information to a first network device 102, where the capability information indicates a first number of reception beams supported by the UE 101 at the same moment.

At step S702, The UE 101 receives first configuration information transmitted by the first network device 102, where the first configuration information indicates the UE 101 to perform mobility measurements simultaneously using the first number of reception beams.

At step S703, the UE 101 receives first indication information transmitted by a first number of network devices in accordance with a setting configuration scheme, where the first indication information indicates activated TCI states of the respective network devices, and the first number of network devices include one first network device 102 and at least one second network device 103 in the same cell.

At step S704, the UE 101 performs beam switching of a first number of beams at the same moment, and performs the mobility measurements simultaneously on the respective network devices using the first number of reception beams corresponding to the activated TCI states after the beam switching.

In some implementations, depending on the capabilities of different UE 101, the counts of reception beams supported by them at the same moment may be different. As illustrated in FIG. 4, the reception beams supported by the UE 101 at the same moment may be at least one of R1-R8.

In some implementations, the first network device 102 adaptively configures the first configuration information based on the capability information of the UE 101.

In some implementations, the first network device 102 transmits second indication information to a second number of second network devices 103, so as to inform these second network devices 103 of the setting configuration scheme supported by the UE 101. Therefore, the second network devices 103 can transmit the first indication information adopting the setting configuration scheme supported by the UE 101, which facilitates simultaneous switching of multiple beams by the UE 101.

In the example of the present disclosure, the UE 101 reports the capability information to the first network device 102, so that the first network device 102 can perform an adaptive configuration or a scheduling adaptation based on the capability of the UE 101, which ensures that the UE 101 can complete the switching of multiple beams at the same time.

In the examples of the present disclosure, a method for transmitting indication information is provided, which is performed by a first network device 102. Referring to FIG. 10, FIG. 10 illustrates a method for transmitting indication information according to an example. As illustrated in FIG. 10, the method includes steps S1001-S1002.

At step S1001, the first network device 102 receives capability information transmitted by UE 101, where the capability information indicates a first number of reception beams supported by the UE 101 at the same moment.

At step S1002, the first network device 102 transmits second indication information to a second number of second network devices 103 in the same cell, where the second indication information indicates a setting configuration scheme for TCI states supported by the UE 101, and the second number is equal to or less than the first number.

In some implementations, depending on the capabilities of different UE 101, the counts of reception beams supported by them at the same moment may be different. As illustrated in FIG. 4, the reception beams supported by the UE 101 at the same moment may be at least one of R1-R8.

In some implementations, the first network device 102 adaptively configures the first configuration information based on the capability information of the UE 101.

In some implementations, the first network device 102 transmits the second indication information to the second number of second network devices 103, so as to inform these second network devices 103 of the setting configuration scheme supported by the UE 101. Therefore, the second network devices 103 can transmit the first indication information adopting the setting configuration scheme supported by the UE 101.

In some implementations, the first network device 102 transmits or does not transmit the first indication information corresponding to itself to the UE 101.

In some implementations, the method disclosed herein further includes that the first network device 102 transmits the first indication information to the UE 101 in accordance with the setting configuration scheme, where the first indication information indicates the activated TCI state configured by the first network device 102.

In an example, in a scenario where the first network device 102 transmits the first indication information corresponding to itself to the UE 101, the second number=(the first number—1).

In an example, in a scenario where the first network device 102 does not transmit the first indication information corresponding to itself to the UE 101, the second number=the first number, which means that, in this example, the first indication information is transmitted by the second number of second network devices 103 in the cell.

In some implementations, in a scenario with the first number of TRPs, the first network device 102 and the at least one second network device 103 are located in the same cell. The first network device 102 may be a primary base station among the first number of TRPs.

In some implementations, the setting configuration scheme indicates: transmitting through a same type of control signalings at a same transmission moment. Alternatively, the setting configuration scheme indicates: transmitting at transmission moments corresponding to control signalings.

In the example of the present disclosure, the first network device 102 learns the reception beams able to be supported by the UE 101 at the same moment based on the capability information reported by the UE 101. On this basis, the first network device 102 may transmit the indication information to the second number of second network devices 103 to indicate these second network devices 103 to issue the TCI states to the UE in accordance with the setting configuration scheme, which facilitates the UE to achieve simultaneous switching of multiple reception beams within its own capability.

In the examples of the present disclosure, a method for transmitting indication information is provided, which is performed by a first network device 102. The method includes steps S1001-S1003.

At step S1001, the first network device 102 receives capability information transmitted by UE 101, where the capability information indicates a first number of reception beams supported by the UE 101 at the same moment.

At step S1002, the first network device 102 transmits second indication information to a second number of second network devices 103 in the same cell, where the second indication information indicates a setting configuration scheme for TCI states supported by the UE 101, and the second number is equal to or less than the first number.

At step S1003, the first network device 102 transmits first configuration information to the UE 101, where the first configuration information indicates the UE 101 to perform mobility measurements simultaneously using the first number of reception beams.

The order of step S1002 and step S1003 is for illustration only, and the order of these two steps may be reversed in other implementations.

In the example of the present disclosure, the first network device 102 performs an adaptive configuration based on the capability of the UE 101, which facilitates informing the second number of second network devices 103 to transmit the first indication information based on the capability of the UE 101. When the UE 101 performs beam switching of multiple reception beams and performs these measurements at the same time, a measurement delay can be effectively reduced.

In the examples of the present disclosure, a method for transmitting indication information is provided, which is performed by a first network device 102. The method includes steps S1001-S1002, and further includes the following step S1004.

At step S1004, the first network device 102 determines transmission moments for the second network devices 103 to transmit different types of control signalings according to different processing delays of the UE 101 for different types of control signalings.

In some implementations, the control signaling is an RRC signaling, an MAC-CE signaling or DCI.

In some implementations, the first network device 102 determines the processing delay of the RRC signaling in the following way: T_{RRC_processing}+TOₖ*(T_{first-SSB}+T_{SSB-proc})/NR slot length.

The T_{RRC_processing} is an RRC processing delay value defined in the protocols. The TOₖ is a delay required for a time-frequency synchronization. TOₖ=0 if the TCI state indicated in the first indication information is included in an activated TCI state list, and TOₖ=1 if the TCI state indicated in the first indication information is not included in the activated TCI state list. The T_{first-SSB} is a time difference between the time when the UE 101 completes the RRC processing and the time when the first processable synchronization signal block (SSB) is received. The T_{SSB-proc} is a demodulation duration after the SSB is detected, which is generally a fixed value of 2 ms. The NR slot length represents a slot length of NR, which is related to a subcarrier spacing (SCS) supported by the UE 101.

In some implementations, the first network device 102 determines the processing delay of the MAC-RRC signaling in the following way: T_{HARQ}+(3 ms+TOₖ*(T_{first-SSB}+T_{SSB-proc}))/NR slot length.

The T_{HARQ} is a time interval between transmitting a downlink signal and reporting by the UE 101 that the reception is complete, which is defined by the protocols. The 3 ms is a duration for processing the MAC-CE signaling. The T_{first-SSB} is a time difference between the time after the UE 101 demodulates the MAC-CE signaling and the time when the first processable SSB is received. The meaning of the TOK, the T_{SSB-proc} and the NR slot length may make reference to the above.

In some implementations, the processing delay of the DCI is related to the capability of the UE 101. Based on the processing delay capability timeDurationForQCL reported by the UE 101, the first network device 102 may determine the processing delay of the DCI is timeDurationForQCL.

In the example of the present disclosure, by combining the delays that the UE 101 processes different signalings, the first network device 102 adaptively configures the transmission moments for the network devices to transmit different signalings, so that the signalings can be processed in sequence on the UE 101 side in combination with the order in which the signalings are received. Therefore, the processing is completed at the same moment, which is conducive to completing the simultaneous switching of multiple beams.

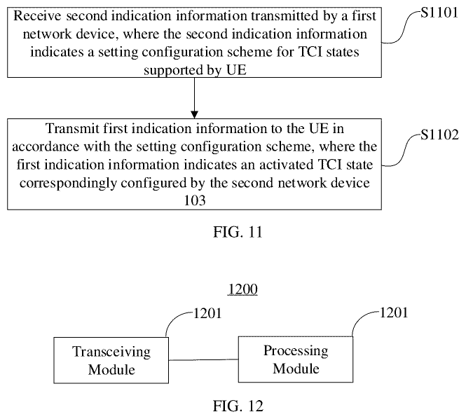

In the examples of the present disclosure, a method for receiving indication information is provided, which is performed by a second network device 103. Referring to FIG. 11, FIG. 11 illustrates a method for receiving indication information according to an example. As illustrated in FIG. 11, the method includes steps S1101-S1102.

At step S1101, the second network device 103 receives second indication information transmitted by a first network device 102, where the second indication information indicates a setting configuration scheme for TCI states supported by UE 101. The second network device 103 and the first network device 102 are located in the same cell.

At step S1102, the second network device 103 transmits first indication information to the UE 101 in accordance with the setting configuration scheme, where the first indication information indicates an activated TCI state correspondingly configured by the second network device 103.

In some implementations, the first network device 102 determines the counts of the second network devices 103 that receive the second indication information based on capability information of the UE 101.

In some implementations, the setting configuration scheme indicates: transmitting through the same type of control signalings at the same transmission moment. Alternatively, the setting configuration scheme indicates: transmitting at transmission moments corresponding to control signalings.

In some implementations, the control signaling is an RRC signaling, an MAC-CE signaling or DCI.

In the example of the present disclosure, the second network device 103 issues the TCI state to the UE 101 in accordance with the setting configuration scheme according to the indication information from the first network device 102, so that the UE 101 can achieve simultaneous switching of multiple reception beams within its own capability, which is conducive for the UE to perform measurements simultaneously to reduce a delay.

In the examples of the present disclosure, a method for receiving indication information is provided, which is performed by a second network device 103. The method includes steps S1101-S1102′, specifically:

At step S1101, the second network device 103 receives second indication information transmitted by a first network device 102, where the second indication information indicates a setting configuration scheme for TCI states supported by UE 101. The second network device 103 and the first network device 102 are located in the same cell.

At step S1102′, a second number of second network devices 103 transmit the same type of control signalings to the UE 101 at the same transmission moment, where the control signalings indicate first indication information corresponding to the second network devices 103. The first indication information indicates activated TCI states configured by the respective second network devices 103.

In some implementations, the setting configuration scheme applied in the example indicates a scenario of transmitting through the same type of control signalings at the same transmission moment.

In some implementations, the control signaling is an RRC signaling, an MAC-CE signaling or DCI.

In an example, all the first number of TRPs adopt the RRC signaling to transmit the first indication information, respectively.

In an example, all the first number of TRPs adopt the MAC-CE signaling to transmit the first indication information, respectively.

In an example, all the first number of TRPs adopt the DCI to transmit the first indication information, respectively.

The second number is equal to or less than the first number.

In some implementations, the signalings adopted by the first number of TRPs are of the same type, and processing delays of the UE 101 are also the same. Therefore, the transmission moments of the first number of TRPs are the same, and the UE 101 processes each TRP signaling at the same processing starting moment, which is conducive to simultaneous switching.

In the examples of the present disclosure, a method for receiving indication information is provided, which is performed by a second network device 103. The method includes steps S1101 to S1102″, specifically:

At step S1101, the second network device 103 receives second indication information transmitted by a first network device 102, where the second indication information indicates a setting configuration scheme for TCI states supported by UE 101. The second network device 103 and the first network device 102 are located in the same cell.

At step S1102″, a second number of second network devices 103 transmit control signalings for indicating first indication information at the respective transmission moments according to the types of control signalings adopted, where the first indication information indicates activated TCI states configured by the respective second network devices 103.

In some implementations, the setting configuration scheme applied in the example indicates a scenario of transmitting at the transmission moments corresponding to the control signalings.

In some implementations, the control signaling is an RRC signaling, an MAC-CE signaling or DCI.

In some implementations, a processing delay of the RRC signaling>a processing delay of the MAC-CE signaling>a processing delay of the DCI. Therefore, the transmission moment of the TRP adopting the RRC signaling is earlier than that of the TRP transmitting other signalings.

In some implementations, different types of signalings are transmitted sequentially in different orders along a time axis, and the time at which the signalings are received by the UE 101 is also different. For the signaling with a longer processing delay, the UE 101 is to receive it earlier and process it earlier with taking the reception moment as a processing starting moment.

Based on the same concept as the method examples, the examples of the present disclosure also provide an apparatus for receiving indication information. The apparatus may be equipped with the functions of the UE 101 in the method examples and may be configured to perform the steps performed by the UE 101 provided in the method examples. The functions may be implemented by hardware, by software, or by hardware executing corresponding software. The hardware or software includes one or more modules corresponding to the above functions.

In an implementation, a communication apparatus 1200 as illustrated in FIG. 12 may act as the UE 101 involved in the method examples, and perform the steps performed by the UE 101 in the method examples. As illustrated in FIG. 12, the communication apparatus 1200 may include a transceiving module 1201 and a processing module 1202 coupled to each other. The transceiving module 1201 may be configured to support communications of the communication apparatus. The transceiving module 1201 may be equipped with a wireless communication function, for example, it may perform wireless communications with another communication device through a wireless air interface. The processing module 1202 may be configured for the communication apparatus to perform processing operations, such as generating information/messages to be transmitted, or processing received signals to obtain information/messages.

During performing the steps implemented by the UE 101, the transceiving module 1201 is configured to receive first indication information transmitted by a first number of network devices in accordance with a setting configuration scheme. The first indication information indicates activated TCI states configured by respective network devices, and the first number of network devices include a first network device and at least one second network device in the same cell.

The processing module 1202 is configured to perform beam switching of a first number of beams at the same moment, and perform mobility measurements simultaneously on the respective network devices using a first number of reception beams corresponding to the activated TCI states after the beam switching.

In some implementations, the setting configuration scheme indicates: transmitting at transmission moments corresponding to control signalings.

The transceiving module 1201 is further configured to receive the control signaling transmitted by each of the first number of network devices at the corresponding transmission moment. The control signaling indicates the first indication information corresponding to the network device.

In some implementations, the processing module 1202 is further configured to determine the first number of reception beams corresponding to the TCI states in the control signalings at the same moment by taking a moment when each control signaling is received as a processing starting moment of the control signaling and processing the control signaling within a processing delay corresponding to the control signaling according to processing starting moments corresponding to different control signalings.

In some implementations, the setting configuration scheme indicates: transmitting through the same type of control signalings at the same transmission moment.

The transceiving module is further configured to receive the first indication information transmitted by the first number of network devices through the same type of control signalings at the same transmission moment.

In some implementations, the control signaling is an RRC signaling, an MAC-CE signaling, or DCI.

In some implementations, the transceiving module 1201 is further configured to transmit capability information to the first network device. The capability information indicates the first number of reception beams supported by the UE at the same moment.

The transceiving module 1201 is further configured to receive first configuration information transmitted by the first network device. The first configuration information indicates the UE to perform the mobility measurements simultaneously using the first number of reception beams.

The transceiving module 1201 is further configured to receive the first indication information transmitted by the first network device among the first number of network devices in accordance with the setting configuration scheme, and/or receive the first indication information transmitted by the second network device among the first number of network devices in accordance with the setting configuration scheme.

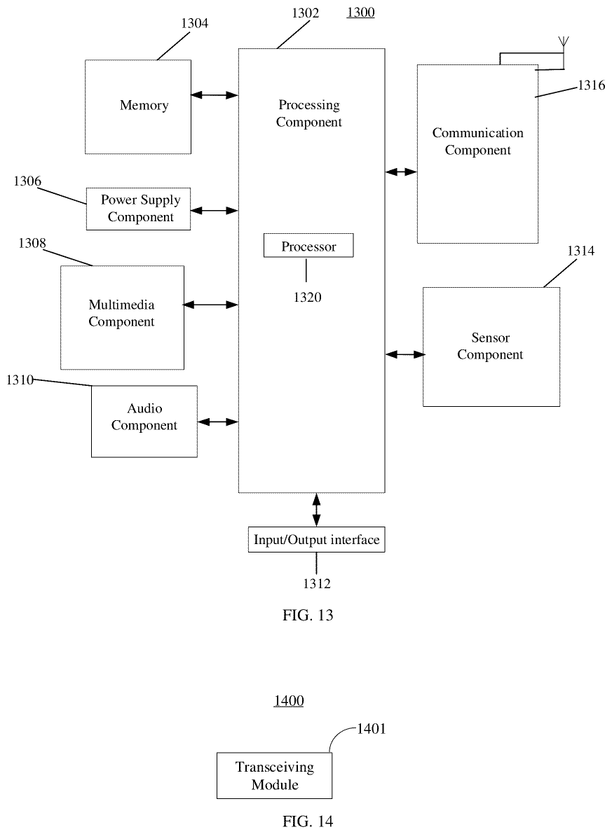

When being UE 101, the structure of the communication apparatus may also be as illustrated in FIG. 13. The apparatus 1300 may be a mobile phone, a computer, a digital broadcast terminal, a message transceiver, a game console, a tablet device, a medical device, a fitness device, a personal digital assistant, and the like.

Referring to FIG. 13, the apparatus 1300 may include one or more of the following components: a processing component 1302, a memory 1304, a power supply component 1306, a multimedia component 1308, an audio component 1310, an input/output (I/O) interface 1312, a sensor component 1314, and a communication component 1316.

The processing component 1302 generally controls the overall operations of the apparatus 1300, such as operations associated with display, phone calls, data communications, camera operations, and recording operations. The processing component 1302 may include one or more processors 1320 to execute instructions to complete all or a part of the steps of the foregoing methods. In addition, the processing component 1302 may include one or more modules which facilitate the interaction between the processing component 1302 and other components. For example, the processing component 1302 may include a multimedia module to facilitate the interaction between the multimedia component 1308 and the processing component 1302.

The memory 1304 is configured to store various types of data to support the operations of the apparatus 1300. Examples of such data include instructions for any application or method operated on the apparatus 1300, contact data, phonebook data, messages, pictures, videos, and the like. The memory 1304 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 1306 provides power for various components of the apparatus 1300. The power supply component 1306 may include a power management system, one or more power supplies, and other components associated with generating, managing, and distributing power for the apparatus 1300.

The multimedia component 1308 includes a screen providing an output interface between the apparatus 1300 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 1308 includes a front camera and/or a rear camera. The front camera and/or rear camera may receive external multimedia data when the apparatus 1300 is in an operating mode, such as a photographing mode or a video mode. Each front camera and rear camera may be a fixed optical lens system or have focal length and optical zooming capability.

The audio component 1310 is configured to output and/or input audio signals. For example, the audio component 1310 includes a microphone (MIC) that is configured to receive external audio signals when the apparatus 1300 is in an operating mode, such as a call mode, a recording mode, and a voice recognition mode. The received audio signals may be further stored in memory 1304 or transmitted via communication component 1316. In some examples, the audio component 1310 also includes a speaker for outputting audio signals.

The I/O interface 1312 provides an interface between the processing component 1302 and a peripheral interface module. The peripheral interface module may be a keyboard, a click wheel, buttons, or the like. These buttons may include but not limited to a home button, a volume button, a start button and a lock button.

The sensor component 1314 includes one or more sensors to provide the apparatus 1300 with state assessments in various aspects. For example, the sensor component 1314 may detect an open/closed state of the apparatus 1300 and a relative positioning of components such as the display and keypad of the apparatus 1300, and the sensor component 1314 may also detect a change in position of the apparatus 1300 or a component of the apparatus 1300, the presence or absence of user contact with the apparatus 1300, orientation or acceleration/deceleration of the apparatus 1300, and temperature change of the apparatus 1300. The sensor component 1314 may include a proximity sensor configured to detect the presence of a nearby object without any physical contact. The sensor component 1314 may also include a light sensor, such as a complementary metal oxide semiconductor (CMOS) or charge-coupled device (CCD) image sensor, for being applied in imaging applications. In some examples, the sensor component 1314 may also include an acceleration sensor, a gyro sensor, a magnetic sensor, a pressure sensor, or a temperature sensor.

The communication component 1316 is configured to facilitate wired or wireless communication between the apparatus 1300 and other devices. The apparatus 1300 may access a wireless network based on a communication standard, such as WiFi, 2G, 3G, 4G, 5G, 6G, or a combination thereof. In an example, the communication component 1316 receives broadcast signals or broadcast related information from an external broadcast management system via a broadcast channel. In an example, the communication component 1316 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the apparatus 1300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the foregoing methods.

In one or more examples, a non-transitory computer-readable storage medium including instructions is provided, such as the memory 1304 including instructions. These instructions may be executed by the one or more processors 1320 of the apparatus 1300 to complete the foregoing methods. For example, the non-transitory computer-readable storage medium may be an ROM, a random access memory (RAM), a compact disc read-only memory (CD-ROM), a magnetic tape, a floppy disk, an optical data storage device, and the like.

Based on the same concept as the method examples, the examples of the present disclosure also provide an apparatus for transmitting indication information. The apparatus may be equipped with the functions of the first network device 102 in the method examples and may be configured to perform the steps performed by the first network device 102 provided in the method examples. The functions may be implemented by hardware, by software, or by hardware executing corresponding software. The hardware or software includes one or more modules corresponding to the above functions.

In an implementation, the apparatus 1400 as illustrated in FIG. 14 may act as the first network device 102 involved in the method examples, and perform the steps performed by the first network device 102 in the method examples. As illustrated in FIG. 14, the apparatus 1400 may include a transceiving module 1401. The transceiving module 1401 may be configured to support the communications of the communication apparatus.

During performing the steps implemented by the first network device 102, the transceiving module 1401 is configured to receive capability information transmitted by the UE 101. The capability information indicates a first number of reception beams supported by the UE 101 at the same moment.

The transceiving module 1401 is further configured to transmit second indication information to a second number of second network devices in the same cell. The second indication information indicates a setting configuration scheme for TCI states supported by the UE, and the second number is equal to or less than the first number.

In some implementations, the transceiving module 1401 is further configured to transmit first configuration information to the UE. The first configuration information indicates the UE to perform mobility measurements simultaneously using the first number of reception beams.

In some implementations, the transceiving module 1401 is further configured to transmit first indication information to the UE in accordance with the setting configuration scheme. The first indication information indicates an activated TCI state configured by the first network device.

In some implementations, the setting configuration scheme indicates: transmitting through the same type of control signalings at the same transmission moment. Alternatively, the setting configuration scheme indicates: transmitting at transmission moments corresponding to control signalings.

In some implementations, the apparatus 1400 also includes a processing module coupled to the transceiving module 1401. The processing module is configured to determine the transmission moments for the second network devices to transmit different types of control signalings according to different processing delays of the UE for the different types of control signalings.

In some implementations, the transceiving module 1401 is further configured to transmit first configuration information to the UE. The first configuration information indicates processing starting moments corresponding to different types of control signalings.

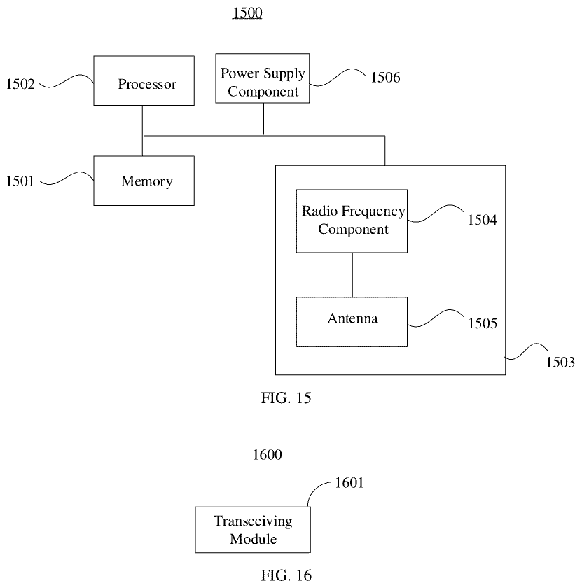

When being the first network device 102, the structure of the communication apparatus may further be as illustrated in FIG. 15. The structure of the communication apparatus is described by taking a base station as an example. As illustrated in FIG. 15, the apparatus 1500 includes a memory 1501, a processor 1502, a transceiving component 1503, and a power supply component 1506. The memory 1501 is coupled to the processor 1502 and may be configured to store programs and data required by the communication apparatus 1500 to implement various functions. The processor 1502 is configured to support the communication apparatus 1500 to perform the corresponding functions in the foregoing methods. These functions may be implemented by calling the programs stored in the memory 1501. The transceiving component 1503 may be a wireless transceiver, which may be configured to support the communication apparatus 1500 to receive signaling and/or data and transmit signaling and/or data through a wireless air interface. The transceiving component 1503 may also be referred to as a transceiving unit or a communication unit. The transceiving component 1503 may include a radio frequency component 1504 and one or more antennas 1505. The radio frequency component 1504 may be a remote radio unit (RRU), which may be specifically configured to transmit radio frequency signals and convert between radio frequency signals and baseband signals. The one or more antennas 1505 may be specifically configured to radiate and receive radio frequency signals.

When the communication apparatus 1500 needs to transmit data, the processor 1502 may perform a baseband processing on the data to be transmitted and output the baseband signals to a radio-frequency unit. The radio-frequency unit performs a radio-frequency processing on the baseband signals and then transmits the radio-frequency signals in the form of electromagnetic waves through the one or more antennas. When data is transmitted to the communication apparatus 1500, the radio-frequency unit receives the radio-frequency signals through the one or more antennas, converts the radio-frequency signals into baseband signals, and outputs the baseband signals to the processor 1502. The processor 1502 converts the baseband signals into data and processes the data.

Based on the same concept as the method examples, the examples of the present disclosure also provide an apparatus for receiving indication information. The apparatus may be equipped with the functions of the second network device 103 in the method examples and is configured to perform the steps performed by the second network device 103 provided in the method examples. The functions may be implemented by hardware, by software, or by hardware executing corresponding software. The hardware or software includes one or more modules corresponding to the above functions.

In an implementation, the apparatus 1600 as illustrated in FIG. 16 may act as the second network device 103 involved in the method examples, and perform the steps performed by the second network device 103 in the method examples. As illustrated in FIG. 16, the apparatus 1600 may include a transceiving module 1601. The transceiving module 1601 may be configured to support the communications of the communication apparatus.

During performing the steps performed by the second network device 103, the transceiving module 1601 is configured to receive second indication information transmitted by a first network device. The second indication information indicates a setting configuration scheme for TCI states supported by UE, and the second network device and the first network device are located in the same cell.

The transceiving module 1601 is further configured to transmit first indication information to the UE in accordance with the setting configuration scheme. The first indication information indicates an activated TCI state correspondingly configured by the second network device.

In some implementations, the setting configuration scheme indicates: transmitting through a same type of control signalings at a same transmission moment. The transceiving module 1601 is further configured to enable a second number of second network devices to transmit the same type of control signalings to the UE at the same transmission moment. The control signalings indicate the first indication information corresponding to the second network devices.

In some implementations, the setting configuration scheme indicates: transmitting at transmission moments corresponding to control signalings. The transceiving module 1601 is further configured to transmit the control signaling that indicates the first indication information at the corresponding transmission moment according to the type of the control signaling adopted.

When being the second network device 103, the structure of the communication apparatus may further be as illustrated in FIG. 15.

Other implementations of the examples of the present disclosure will be readily apparent to those skilled in the art after implementing the present disclosure by referring to the description. The present disclosure is intended to cover any variations, uses, or adaptations of the examples of the present disclosure that are in accordance with the general principles thereof and include common general knowledge or conventional technical means in the art that are not disclosed in the present disclosure. The description and the examples are only illustrative, and the true scope and spirit of the examples of the present disclosure are set forth in the appended claims.

It is to be understood that the examples of the present disclosure are not limited to the above-described accurate structures illustrated in the accompanying drawings, and various modifications and changes may be made to the present disclosure without departing from the scope thereof. The scope of the examples of the present disclosure is limited only by the appended claims.

### Industrial Practicality

In the examples of the present disclosure, multiple network devices in the same cell may issue activated TCI states in accordance with a setting configuration scheme, respectively. UE achieves simultaneous switching of multiple reception beams according to the TCI states issued by the network devices in accordance with the setting configuration scheme, so that the measurements on multiple network devices can be performed simultaneously, which is conducive to reducing a measurement delay.

1. A method for receiving indication information, performed by user equipment (UE), the method comprising:
receiving first indication information transmitted by a first number of network devices in accordance with a setting configuration scheme, wherein the first indication information indicates activated transmission configuration indication (TCI) states configured by respective network devices, and the first number of network devices comprise a first network device and at least one second network device in a same cell;
performing beam switching of a first number of beams at a same moment, and
performing mobility measurements simultaneously on the respective network devices using a first number of reception beams corresponding to the activated TCI states after the beam switching.

2. The method according to claim 1,
wherein the setting configuration scheme indicates:
transmitting at transmission moments corresponding to control signalings; and
wherein receiving the first indication information transmitted by the first number of network devices in accordance with the setting configuration scheme comprises:
receiving the control signaling transmitted by each of the first number of network devices at the corresponding transmission moment, wherein the control signaling indicates the first indication information corresponding to the network device.

3. The method according to claim 2, further comprising:
determining the first number of reception beams corresponding to the TCI states indicated by the first indication information in the control signalings at a same moment by taking a moment when each control signaling is received as a processing starting moment of the control signaling and processing the control signaling within a processing delay corresponding to the control signaling according to processing starting moments corresponding to different control signalings.

4. The method according to claim 1,
wherein the setting configuration scheme indicates:
transmitting through a same type of control signalings at a same transmission moment; and
wherein receiving the first indication information transmitted by the first number of network devices in accordance with the setting configuration scheme comprises:
receiving the first indication information transmitted by the first number of network devices through the same type of control signalings at the same transmission moment.

5. The method according to claim 4, wherein the control signaling is a radio resource control (RRC) signaling, a media access control layer control element (MAC-CE) signaling, or downlink control information (DCI).

6. The method according to claim 1, further comprising:
transmitting capability information to the first network device, wherein the capability information indicates the first number of reception beams supported by the UE at a same moment; and
receiving first configuration information transmitted by the first network device, wherein the first configuration information indicates the UE to perform the mobility measurements simultaneously using the first number of reception beams.

7. The method according to claim 1, wherein receiving the first indication information transmitted by the first number of network devices in accordance with the setting configuration scheme comprises at least one of:
receiving the first indication information transmitted by the first network device among the first number of network devices in accordance with the setting configuration scheme, or
receiving the first indication information transmitted by the at least one second network device among the first number of network devices in accordance with the setting configuration scheme.

8. A method for transmitting indication information, performed by a first network device, the method comprising:
receiving capability information transmitted by user equipment (UE), wherein the capability information indicates a first number of reception beams supported by the UE at a same moment; and
transmitting second indication information to a second number of second network devices in a same cell, wherein the second indication information indicates a setting configuration scheme for transmission configuration indication (TCI) states supported by the UE, and the second number is equal to or less than the first number.

9. The method according to claim 8, further comprising:
transmitting first configuration information to the UE, wherein the first configuration information indicates the UE to perform mobility measurements simultaneously using the first number of reception beams.

10. The method according to claim 8, further comprising:
transmitting first indication information to the UE in accordance with the setting configuration scheme, wherein the first indication information indicates an activated TCI state configured by the first network device.

11. The method according to claim 8, wherein
the setting configuration scheme indicates:
transmitting through a same type of control signalings at a same transmission moment; or
transmitting at transmission moments corresponding to control signalings.

12. The method according to claim 11, further comprising:
determining the transmission moments for the second network devices to transmit different types of control signalings according to different processing delays of the UE for the different types of control signalings.

13. A method for receiving indication information, performed by a second network device, the method comprising:
receiving second indication information transmitted by a first network device, wherein the second indication information indicates a setting configuration scheme for transmission configuration indication (TCI) states supported by user equipment (UE), and the second network device and the first network device are located in a same cell; and
transmitting first indication information to the UE in accordance with the setting configuration scheme, wherein the first indication information indicates an activated TCI state configured by the second network device.

14. The method according to claim 13,
wherein the setting configuration scheme indicates:
transmitting through a same type of control signalings at a same transmission moment; and
wherein transmitting the first indication information to the UE in accordance with the setting configuration scheme comprises:
transmitting the same type of control signalings by a second number of second network devices to the UE at the same transmission moment, wherein the control signalings indicate the first indication information corresponding to the second network devices.

15. The method according to claim 13,
wherein the setting configuration scheme indicates:
transmitting at transmission moments corresponding to control signalings; and
wherein transmitting the first indication information to the UE in accordance with the setting configuration scheme comprises:
transmitting the control signaling that indicates the first indication information at the corresponding transmission moment according to the type of the control signaling adopted.

16.-18. (canceled)

19. A communication device, comprising
one or more processors, and
the one or more memories storing a computer program,
wherein the one or more processors are configured to perform the method according to claim 1.

20. A communication device, comprising
one or more processors, and
one or more memories storing a computer program,
wherein the one or more processors are configured to perform the method according to claim 8.

21. A communication device, comprising
one or more processors, and
one or more memories storing a computer program,
wherein the one or more processors are configured to perform the method according to claim 13.

22.-24. (canceled)

25. The method according to claim 2, wherein the control signaling is a radio resource control (RRC) signaling, a media access control layer control element (MAC-CE) signaling, or downlink control information (DCI).

26. The method according to claim 10, wherein
the setting configuration scheme indicates:
transmitting through a same type of control signalings at a same transmission moment; or
transmitting at transmission moments corresponding to control signalings.
